(19) United States
(12) Patent Application Publication
(10) Pub. No.: US 2025/0231302 A1
(43) Pub. Date: Jul. 17, 2025

(54) Method for Tracking GNSS Signals with a Control Loop Used Only for Phase Control and a Control Loop Used Only for Doppler Frequency Control

(71) Applicant: Robert Bosch GmbH, Stuttgart (DE)

(72) Inventors: David Oertel, Hannover (DE); Christian Skupin, Garbsen (DE); Nikolay Mikhaylov, Hildesheim (DE); Valery Chistyakov, St. Petersburg (RU)

(21) Appl. No.: 19/018,265

(22) Filed: Jan. 13, 2025

(30) Foreign Application Priority Data
Jan. 16, 2024 (DE) 10 2024 200 356.5

(51) Int. Cl. G01S 19/29; G01S 19/37

(52) U.S. Cl. CPC G01S 19/29; G01S 19/37

(57) ABSTRACT

A method for tracking GNSS signals using a GNSS receiver, a phase-based filter, and a frequency-based filter. The generator is controllable in epochs by the two control loops. A GNSS signal is tracked on the channel. The method includes a) creating a local replica with a channel generator, b) generating a first control variable in the form of a phase exclusively with a phase-based filter of a first control loop, c) generating a second control variable in the form of a Doppler frequency using only a frequency-based filter of a second control loop, d) updating the replica under the control of the generator either directly with the first control variable and the second control variable or with a corrected second control variable that has been corrected taking into account the first control variable, and e) repeating b) through d) to update the replica.

This application claims priority under 35 U.S.C. § 119 to application no. DE 10 2024 200 356.5, filed on Jan. 16, 2014 in Germany, the disclosure of which is incorporated herein by reference in its entirety.

The present disclosure relates to a method for tracking GNSS signals with a control loop used only for phase control and a control loop used only for Doppler frequency control. Furthermore, a GNSS receiver, a control unit, a computer program and a machine-readable storage medium are indicated. The disclosure can particularly be used in GNSS-based localization systems for autonomous or semi-autonomous driving.

### BACKGROUND

Currently, there are a variety of vector tracking (VT) approaches for tracking GNSS satellites, which have been developed based on the well-known scalar tracking (ST) approaches to improve tracking capability. Vector tracking approaches can be categorized into three main types, namely frequency-based vector frequency lock loops (VFLL), code-based vector delay lock loops (VDLL), and phase-based vector phase lock loops (VPLL). Using a (virtual) base station as the reference unit, the vector tracking approaches can be extended, including, e.g., differential vector phase lock loops (DVPLL).

A GNSS signal is basically a carrier wave with codes. Signal tracing therefore has two main tasks: code control and carrier control. Code control is normally performed with a code-based lock loop (e.g. DLL or VDLL) and carrier control with a phase-based lock loop (e.g. PLL, VPLL or DVPLL) and/or a frequency-based lock loop (e.g. FLL or VFLL).

For carrier control, a phase-based lock loop usually has a higher accuracy but is less robust than a frequency-based lock loop. Therefore, in a known embodiment (e.g., the FLL-based PLL tracking loop (F-PLL)), a frequency-based lock loop supports the phase-based lock loop in such a way that the two lock loops are activated alternately, e.g., by activating the frequency-based lock loop frequency-based lock loop is activated for Doppler frequency control in order to detect a GNSS signal to be tracked more quickly, and then the phase-based lock loop is activated for phase and Doppler frequency control in order to track the detected GNSS signal more accurately. However, the alternating activation of the two lock loops causes filters and/or parameters to change during control and regulation, leading to interference that impairs the stability of the signal tracking. Therefore, it is desirable to abolish the alternating activation of the two lock loops in order to improve the reliability and robustness of the signal tracking system as a whole.

### SUMMARY

Proceeding therefrom, the object of the present disclosure is to alleviate or at least partially solve the problems described in relation to the prior art. In particular, a method for tracking GNSS signals with a control loop used only for phase control and a control loop used only for Doppler frequency control is to be given, which makes it possible to carry out the phase control and the Doppler frequency control each with its own control loop without alternating, but with simultaneous activation of both control loops, so that the phase control and the Doppler frequency control can support and improve each other, thereby increasing the accuracy, robustness and stability of the signal tracking and thus improving the overall tracking performance.

A method for tracking GNSS signals using a GNSS receiver having a plurality of channels, wherein at least one channel comprises a generator, a phase-based filter and a frequency-based filter, such that the generator forms a first control loop with the phase-based filter and a second control loop with the frequency-based filter, so that the generator is controllable in epochs with the two control loops for generating a local replica and for updating the replica, and wherein a GNSS signal is tracked on the at least one channel with the following steps:
a) creating a local replica using the generator,
b) detecting an initial control variable in the form of a phase exclusively with the phase-based filter of the first control circuit,
c) detecting a second control variable in the form of a Doppler frequency using only the frequency-based filter of the second control circuit,
d) updating the replica under the control of the generator, either directly with the first control variable and the second control variable, or at least with a corrected second control variable that has been corrected taking into account the first control variable, and
e) repeating steps b) through d) to update the replica epoch by epoch.

The method described here can be used to navigate a vehicle by calculating a navigation solution using tracked GNSS signals, such as e.g., a classic position-velocity-time (PVT) prediction for single point positioning (SPP). The method described is particularly suitable for autonomous driving. In this context, autonomous driving refers to the movement of vehicles that behave largely autonomously by means of a GNSS receiver and based on Global Navigation Satellite Systems (GNSS). The vehicles may be motor vehicles, for example a passenger car, a truck or another commercial vehicle, a robot or similar. It is particularly advantageous if a vehicle is equipped with a GNSS receiver, which is used to carry out the described method and to navigate the vehicle.

A GNSS receiver described herein may have multiple channels, such that multiple GNSS signals may be tracked simultaneously on multiple channels, wherein each GNSS signal is tracked on a single channel. It may be provided that steps a) to d) are carried out simultaneously on several channels so that several GNSS signals can be tracked simultaneously to calculate a navigation solution.

A GNSS signal is basically a high-frequency carrier wave with modulated low-frequency codes. A channel is thus a signal processing unit configured for carrier and code control in such a way that, in the case of carrier control, the phase and frequency of the carrier wave of a GNSS signal are tracked and, in the case of code control, the codes modulated onto the carrier wave are recovered.

Since the phase of the carrier wave of a GNSS signal can change due to the time lag between transmission and reception and the frequency of the carrier wave can change due to the Doppler effect, the carrier control in particular performs the phase control and the Doppler frequency control. A generator is used to create a local replica whose phase and frequency track the phase and frequency of the carrier wave of a GNSS signal to be tracked, so that the phase and frequency of the replica are always in a certain ratio to the phase and frequency of the carrier wave, thus enabling the tracking of this GNSS signal.

In particular, the generator is an NCO (NCO: Numerically Controlled Oscillator) that can be controlled epoch by epoch with at least one closed control loop via at least one control variable, so that the phase and frequency of the generator can be updated epoch by epoch such that the phase and frequency of the replica are always in a specified relationship with the phase and frequency of the received carrier wave. The phase and Doppler frequency control here refers to the epoch-making control of the generator to create a phase- and frequency-controlled replica.

It may be provided that at least one channel is configured to include a first control loop and a second control loop, so that the first control loop can be used exclusively for phase control and the second control loop can be used exclusively for Doppler frequency control. The first control circuit and the second control circuit are connected in parallel to each other and are always activated or deactivated simultaneously. A switch to activate the two control circuits alternately is therefore no longer required.

It can be provided that the first control loop comprises at least one phase-based filter that generates a first control variable, for example in epoch n. This first control variable is used to correct the phase of the replica in epoch n+1. The correction is derived from the phase residual between the NCO phase in epoch n and the control variable in epoch n, wherein n is a natural number. Alternatively, the first control variable in epoch n can be used directly to update the phase of the generator in epoch n. In addition, the first control loop can include a phase-based correlator and a phase-based discriminator. The first control loop is thus formed at least by the phase-based correlator, the phase-based discriminator, the phase-based filter and the generator.

It can be provided that the second control loop comprises at least one frequency-based filter that generates a second control variable at epoch n, for example. The second control variable can be a currently determined Doppler frequency, which is used in epoch n+1 to update only the frequency or both the frequency and the phase of the replica, wherein n is a natural number. In addition, the second control loop can include a frequency-based correlator and a frequency-based discriminator. The second control loop is thus formed at least by the frequency-based correlator, the frequency-based discriminator, the frequency-based filter and the generator.

It may be provided that the phase-based correlator and the frequency-based correlator are configured to a common signal processing arrangement and the phase-based discriminator and the frequency-based discriminator are configured to a common discriminator arrangement. Thus, the first control loop is formed by the signal processing arrangement, the discriminator arrangement, the phase-based filter and the generator, while the second control loop is formed by the signal processing arrangement, the discriminator arrangement, the frequency-based filter and the generator.

When a GNSS signal is received on a channel, a local replica is generated using the generator, as in step a). Subsequently, steps b) to d) are repeated epoch by epoch to update the phase and frequency of the replica epoch by epoch, thus tracking the phase and frequency of the carrier wave of the GNSS signal. In a given epoch, the phase and frequency of the replica are updated once. An epoch is designated by a natural number n, wherein n is, for example, the current epoch, n−1 the immediately preceding epoch and n+1 the immediately following epoch.

In step b), an initial control variable in the form of a phase is detected exclusively with the phase-based filter of the first control circuit. The phase detected by the phase-based filter is labeled PHI_n, wherein n is the epoch number. The phase PHI_n detected in epoch n with the phase-based filter can control the phase of the replica to be updated as the control variable. In epoch n, the PHI_n is detected exclusively with the first control loop, e.g. by correlating the replica in epoch n with the GNSS signal in epoch n with the phase-based correlator, determining the phase between the replica at epoch n and the GNSS signal at epoch n using the phase-based discriminator, and detecting the PHI_n based on the determined phase deviation using the phase-based filter.

In step c), a second control variable is detected in the form of a Doppler frequency, but only with the frequency-based filter of the second control loop. The Doppler frequency detected with the frequency-based filter is labeled fd_n, wherein n is the epoch number. The fd_n detected in epoch n with the frequency-based filter can be used as a control variable to regulate only the frequency or both the frequency and the phase of the replica to be updated in epoch n+1. In epoch n, fd_n is generated exclusively with the second control loop, e.g. by correlating the replica in epoch n with the GNSS signal in epoch n with the frequency-based correlator, determining the frequency between the replica at epoch n and the GNSS signal at epoch n with the frequency-based discriminator, and the detecting of the fd_n is based on the determined frequency deviation with the frequency-based filter.

In principle, steps b) and c) are carried out in parallel and simultaneously, so that the first control loop and the second control loop are active at the same time.

In accordance with step d), the replica is updated either directly with the first and second control variable or at least with a corrected second control variable, which has been corrected at least taking into account the first control variable. This means that, depending on the application scenario, there are at least two ways to control the generator.

According to the first possibility, the first and second control variables are used directly to control the generator without correction. This means that the PHI_n detected in step b) exclusively with the first control loop and the fd_n detected in step c) exclusively with the second control loop are entered directly into the generator without correction. This is particularly advantageous for reducing the computational effort if, for example, the GNSS signal to be tracked can be received in an open area, e.g. on a highway, with a good carrier-to-noise ratio, since in such an application scenario PHI_n and fd_n can match sufficiently well.

According to the other possibility, at least the second control variable is corrected taking into account the first control variable and at least the corrected second disturbance variable is used to control the generator. This is particularly advantageous for accurate and robust signal tracking, e.g. when the GNSS signal to be tracked is received in urban environments with poor carrier-to-noise ratio and/or multipath effects. In such an application scenario, PHI_n and fd_n can no longer match sufficiently well, so that PHI_n and fd_n can no longer be entered directly into the generator. A correction of PHI_n and/or fd_n is beneficial. In principle, PHI_n and fd_n can be corrected reciprocally, e.g. by correcting PHI_n with the fd_n integrated over the time difference dT between two epochs (i.e. by the integral calculus), and fd_n is corrected with the deviation between PHI_n and the phase of the replicate updated in epoch n+1, differentiated over the time difference dT (i.e. by the differential calculus).

The following steps can be taken to determine the corrected second control variable:
i) determining the phase of the replica at the time n, which is labeled Phi_n and can be read directly from the generator.
ii) detecting the phase PHI_n at epoch n with the phase-based filter of the first control loop and detecting the Doppler frequency fd_n at epoch n with the frequency-based filter of the second control loop, wherein PHI_n is the first control variable and fd_n is the second control variable,
iii) calculating a phase residual by comparing PHI_n+1 with the sum of Phi_n and the time-differentially integrated fd_n according to the formula dPHI=Phi_n+fd_n*dT-PHI_n+1, wherein dPHI is the phase residual, dT is the time difference between epoch n and epoch n+1, and PHI_n+1 is the phase at epoch n+1 as detected by the phase-based filter of the first control loop.
iv) calculating a corrected second control variable at epoch n+1 according to the formula F_n+1=fd_n+1+dPHI/dT, wherein fd_n+1 is the Doppler frequency at epoch n+1 detected with the frequency-based filter of the second control loop, and F_n+1 is the second corrected control variable at epoch n+1, and wherein the second corrected control variable is substantially the Doppler frequency filtered with the first disturbance variable, i.e. phase estimation, and
v) Rules of the generator for generating the replica at epoch n+2 with the corrected second control variable F_n+1, wherein the phase residual dPHI can also be equalized within dT.

In contrast to the known approaches, in which the carrier is either controlled by a single control loop (e.g. PLL or FLL) or by two control loops that are active in alternating time periods (e.g. F-PLL), in the method described here the carrier is controlled by two simultaneously active control loops, so that one control loop is used only for phase control and the other control loop only for Doppler frequency control. This has the particular advantage that phase and Doppler frequency control can support and enhance each other, increasing the accuracy and robustness of signal tracking. Instead of alternating activation between two control loops, two control loops are always active simultaneously in the method described here, which can also improve the stability of signal tracking.

It is preferable to calculate a phase residual between the last updated phase of the replicate and the currently detected first control variable, taking into account the last detected second control variable, before step d). The phase residual can be calculated using the method described in sub-step (iii).

It is preferable for the second control variable to be corrected using the phase residual. The second control variable can be corrected using the method described in sub-step iv).

It is preferred if a threshold value is specified for the phase residual. The threshold is, for example, a fixed parameter that represents the maximum correction of the generator phase and is referred to here as PHI_corr_max. By comparing the threshold value with the phase residual, a decision can be made as to whether the generator should be controlled directly with the first and second control variables or at least with a corrected second control variable in step d).

It is preferred if in step d) the replica is updated directly with the first and second control variables, with the generator being controlled, if the phase residual is less than or equal to the threshold value.

It is also preferable if, in step d), the replica is updated with at least the corrected second control variable, if the phase residual is greater than the threshold value.

By comparing the phase residual dPHI calculated in sub-step iii) with the specified threshold value PHI_corr_max, the following sub-steps can be carried out in step d) depending on the result of the comparison:
If dPHI<=PHI_corr_max, the PHI_n detected in sub-step ii) is used for the phase control of the generator and the fd_n detected in sub-step ii) is used for the Doppler frequency control of the generator, i.e. the generator is controlled directly with the first and second control variables without correction;
If dPHI>PHI_corr_max, the threshold value PHI_corr_max is used for the phase control of the generator instead of the PHI_n determined in sub-step ii) and the F_n+1 calculated according to the formula F_n+1=fd_n+1+dPHI2/dT is used for the Doppler frequency control of the generator, wherein dPHI2 corresponds to the difference between dPHI and PHI_corr_max. In this case, the generator is essentially controlled with a corrected first and a corrected second control variable.

Further, a GNSS receiver is proposed comprising a plurality of channels adapted to track GNSS signals, wherein at least one channel comprises a generator, a phase-based filter and a frequency-based filter such that the generator forms a first control loop with the phase-based filter and a second control loop with the frequency-based filter, wherein the first control loop is configured to control the generator exclusively with a first control variable in the form of a phase, and wherein the second control loop is configured to control the generator exclusively with a second control variable in the form of a Doppler frequency.

It is preferred that the first control loop and the second control loop are connected in parallel and are simultaneously active when tracking a GNSS signal.

It is preferred if the first control loop is a scalar phase-locked loop or a vector phase-locked loop or a differential vector phase-locked loop.

It is preferred if the second control loop is a scalar frequency lock loop or a vector frequency lock loop.

It is preferable if the generator can be adjusted via phase and Doppler frequency or only via Doppler frequency.

It is preferred that a control device for the GNSS receiver is set up to perform a method as described.

It is additionally preferred if a computer program is used to carry out a method described here. In other words, this relates in particular to a computer program (product) comprising commands which, when the program is executed by a computer, prompt said computer to perform a method described herein.

It is also preferable if a machine-readable storage medium is used, on which the computer program proposed herein is stored. The machine-readable storage medium is typically a computer-readable data carrier.

The solution presented here and its technical environment are explained in more detail below, using the figures. It should be noted that the disclosure is not intended to be limited by the exemplary embodiments shown. In particular, unless explicitly stated otherwise, it is also possible to extract partial aspects of the facts explained in the figures and to combine them with other components and/or insights from other figures and/or the present description. It shows schematically and by way of example:

### BRIEF DESCRIPTION OF THE DRAWINGS

FIG. 1 shows a conventional FLL-supported PLL control circuit, and

FIG. 2 shows a proposed FLL-assisted PLL control loop.

### DETAILED DESCRIPTION

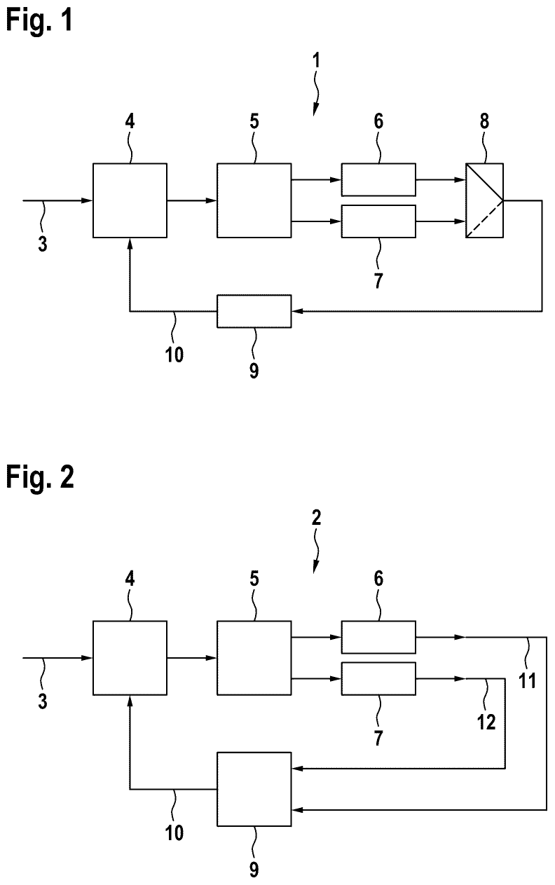

FIG. 1 shows a simplified representation of a conventional FLL-based PLL control circuit 1 for phase and Doppler control of a generator 9 for generating a local replica 10 of the incoming GNSS signal 3.

A switch 8 is used to alternately form and activate either a phase-locked loop or a frequency-locked loop, wherein the phase-locked loop is formed by a signal processing arrangement 4, a discriminator arrangement 5, a phase-based based filter 6 and the generator 9, while the frequency control loop is formed by the signal processing arrangement 4, the discriminator arrangement 5, a frequency-based filter 7 and the generator 9. In this way, the generator 9 can be controlled either only with the control variable determined by the phase-based filter 6 or only with the control variable determined by the frequency-based filter 7 (see the dashed line in switch 8). This has the disadvantage that the alternating activation of the two control loops leads to filter and/or parameter changes during control operation and thus to disturbances that impair the stability of the signal tracking. Another disadvantage is that the control variable determined with the phase-based filter 6 and that determined with the frequency-based filter 7 cannot be corrected against each other.

Analogous to the conventional FLL-based PLL control loop 1 shown in FIG. 1, the FLL-based PLL control loop 2 proposed in FIG. 2 also consists of a phase control loop, which is formed by a signal processing arrangement 4, a discriminator arrangement 5, a phase-based filter 6 and a generator 9, and a frequency control loop formed by the signal processing arrangement 4, the discriminator arrangement 5, a frequency-based filter 7 and the generator 9.

In contrast to the conventional FLL-assisted PLL control loop 1 shown in FIG. 1, the FLL-assisted PLL control loop 2 proposed in FIG. 2 has no switch. Therefore, the two control loops are always activated or deactivated at the same time. This can improve the stability of the signal tracking because the alternating activation of the two control loops is no longer necessary. Furthermore, the generator 9 can be controlled both with the first control variable 11 determined with the phase-based filter 6 and with the second control variable 12 determined with the frequency-based filter 7. If the carrier-to-noise ratio is good, the generator 9 can be controlled directly using the first control variable 11 and the second control variable 12, or if the carrier-to-noise ratio is poor, it can be controlled using a corrected first and a corrected second control variable, wherein in particular the first control variable 11 and the second control variable 12 can be corrected mutually. This can improve the accuracy and robustness of the signal tracking.

With the proposed FLL-based PLL control loop 2, a GNSS signal 3 can be tracked using the following steps:
I) determining the phase of the replica at the time n, which is labeled Phi_n and can be read directly from the generator.
II) detecting the phase PHI_n at epoch n with the phase-based filter of the first control loop and detecting the Doppler frequency fd_n at epoch n with the frequency-based filter of the second control loop, wherein PHI_n is the first control variable and fd_n is the second control variable,
III) calculating a phase residual by comparing PHI_n+1 with the sum of Phi_n and the time-differentially integrated fd_n according to the formula dPHI=Phi_n+fd_n*dT-PHI_n+1, wherein dPHI is the phase residual, dT is the time difference between epoch n and epoch n+1, and PHI_n+1 is the phase at epoch n+1 as detected by the phase-based filter of the first control loop.
IV) comparing the phase residual dPHI calculated in step III) with a specified threshold value PHI_corr_max,
V) executing the following steps:
   1) If dPHI<=PHI_corr_max, the PHI_n detected in sub-step II) is used for the phase control of the generator and the fd_n detected in sub-step II) is used for the Doppler frequency control of the generator, or
   2) If dPHI>PHI_corr_max, the threshold value PHI_corr_max is used for the phase control of the generator instead of the PHI_n detected in sub-step II), and the F_n+1 calculated according to the formula F_n+1=fd_n+1+dPHI2/dT, wherein dPHI2 corresponds to the difference between dPHI and PHI_corr_max, and wherein fd_n+1 is the Doppler frequency detected with the frequency-based filter of the second control loop at epoch n+1, and
VI) Rules of the generator for updating the replica (or the control variables of the generator for epoch n+1) either according to sub-step 1) or sub-step 2).

If the generator 9 can only be controlled via the Doppler frequency, the generator 9 can only be controlled with a second control variable 12 or with a corrected second control variable. In this case, the first control variable 11 can be fed into a measurement production engine to correct the phase measurements. This can be realized by a parameter PHASE_OUT_CORR, which is added to the phase output value PHASE_OUT of the measurement-production engine, wherein the phase output value PHASE_OUT can be detected by evaluating the internal state of the generator 9 according to the formula PHASE_OUT′=PHASE_OUT+PHASE_OUT_CORR, and wherein PHASE_OUT′ is the corrected phase output value of the measurement-production engine, and wherein PHASE_OUT_CORR can be detected as follows:
PHASE_OUT_CORR=PHI-PHASE_OUT, if there is a good carrier-to-noise ratio and the generator is controlled directly by the uncorrected second control variable 12, or
PHASE_OUT_CORR=dPHI, if dPHI<=PHI_corr_max, or
PHASE_OUT_CORR=PHI_corr_max if dPHI>PHI_corr_max.

What is claimed is:

1. A method for tracking GNSS signals using a GNSS receiver having a plurality of channels, wherein at least one channel comprises a generator, a phase-based filter, and a frequency-based filter, such that the generator forms a first control loop with the phase-based filter and a second control loop with the frequency-based filter, so that the generator is controllable in epochs using the first and second control loops for generating a local replica and for updating the local replica, and wherein a GNSS signal is tracked on the at least one channel, comprising:
a) creating a local replica with the generator;
b) detecting a first control variable in the form of a phase exclusively with the phase-based filter of the first control loop;
c) detecting a second control variable in the form of a Doppler frequency using only the frequency-based filter of the second control loop;
d) updating the local replica under control of the generator either directly with the first control variable and the second control variable or with a corrected second control variable that has been corrected taking into account the first control variable; and
e) repeating steps b) through d) to update the local replica epoch by epoch.

2. The method according to claim 1, wherein, before step d), a phase residual between a last updated phase of the local replica and a currently detected first control variable is additionally calculated taking into account a last detected second control variable.

3. The method according to claim 2, wherein the second control variable is corrected with the phase residual.

4. The method according to claim 2, wherein a threshold value is predetermined for the phase residual.

5. The method according to claim 4, wherein in step d) the local replica is updated directly with the first control variable and the second control variable, with the generator regulated, when the phase residual is smaller than or equal to the threshold value.

6. The method according to claim 4, wherein in step d) the local replica is updated with the corrected second control variable, with the generator regulated, when the phase residual is greater than the threshold value.

7. A GNSS receiver comprising:
a plurality of channels that are set up to track GNSS signals,
wherein
at least one channel of the plurality of channels comprises a generator, a phase-based filter and a frequency-based filter, such that the generator forms a first control loop with the phase-based filter and a second control loop with the frequency-based filter,
the first control loop is set up to control the generator solely with a first control variable in the form of a phase, and
the second control loop is set up to control the generator solely with a second control variable in the form of a Doppler frequency.

8. The GNSS receiver according to claim 7, wherein the first control loop and the second control loop are connected in parallel with each other and are simultaneously active when tracking a GNSS signal.

9. The GNSS receiver according to claim 7, wherein the first control loop is one of a scalar phase lock loop, a vector phase lock loop, and a differential vector phase lock loop.

10. The GNSS receiver according to claim 7, wherein the second control loop is one of a scalar frequency lock loop, and a vector frequency lock loop.

11. The GNSS receiver according to claim 7, in which the generator is one of controlled via phase and Doppler frequency, and controlled via Doppler frequency.

12. The GNSS receiver according to claim 7, further comprising:
a control unit configured to
a) create a local replica with the generator;
b) detect a first control variable in the form of a phase exclusively with the phase-based filter of the first control loop;
c) detect a second control variable in the form of a Doppler frequency using only the frequency-based filter of the second control loop;
d) update the local replica under control of the generator either directly with the first control variable and the second control variable or with a corrected second control variable that has been corrected taking into account the first control variable; and
e) repeat steps b) through d) to update the local replica, epoch by epoch.

13. A computer program configured to carry out the method according to claim 1.

14. A machine-readable storage medium on which the computer program according to claim 13 is stored.
